(19) United States
(12) Patent Application Publication
(10) Pub. No.: US 2017/0250551 A1
(43) Pub. Date: Aug. 31, 2017

(54) ENERGY STORAGE DEVICE AND MODULAR CIRCUIT

(71) Applicant: POLYVALOR, LIMITED PARTNERSHIP, Montreal (CA)

(72) Inventors: Georges-Emile APRIL, Montreal (CA); Frederic SIROIS, Montreal (CA); Jean-Nicolas MORIN, Quebec (CA)

(21) Appl. No.: 15/513,308

(22) PCT Filed: Sep. 22, 2015
(86) PCT No.: PCT/CA2015/050934

§ 371 Date: Mar. 22, 2017

Related U.S. Application Data
(60) Provisional application No. 62/053,278, filed on Sep. 22, 2014.

(51) Int. Cl. H02J 7/00

(52) U.S. Cl. CPC H02J 7/0026; H02J 7/0093; H02J 7/0068; H02J 7/345

(57) ABSTRACT

There is described a storage device configured to store energy at one or more given voltage levels. There is also described a storage circuit that may form part of a storage device and is responsible for storing electrical energy and discharging the electrical energy. And finally, there is described a modular circuit having a plurality of storage devices connected in series. The storage devices store electrical energy and provide a voltage level that may be switched in and out of the chain of storage devices in order to control an overall voltage level of the circuit. Each storage device may be individually protected from overvoltage while globally controlled for a given function.

### CROSS-REFERENCE TO RELATED APPLICATIONS

This application claims priority under 35 U.S.C. 119(e) to U.S. application No. 62/053,278 filed Sep. 22, 2014, entitled “Modular Energy Storage Device”, the entire contents of which are hereby incorporated by reference.

### TECHNICAL FIELD

The present invention relates to the field of energy storage devices capable of storing large quantities of energy and operating at high power levels.

### BACKGROUND OF THE ART

Many applications require the ability to store and/or discharge large quantities of energy in a relatively short amount of time, i.e. a high power level must be managed bidirectionally. Conventional batteries can store large quantities of energy but are limited in terms of discharge rate. They are therefore not adequate to function at high power levels. Capacitors are capable of absorbing or discharging electrical energy at much higher power levels, but with a lower storage capacity than batteries. Supercapacitors, such as electric double-layer capacitors (EDLC), bridge the gap between conventional capacitors and rechargeable batteries as they have increased storage capacity and can operate at high power levels.

Most applications that use capacitors (super or regular) for energy storage require a power converter between the capacitor bank and the rest of the system. Such a configuration often results in switching losses and electromagnetic emissions, and increases the overall size of the system. In addition, a voltage balancing circuit is usually needed in order to maximize the energy storage capability of the capacitor bank.

There is therefore a need to address the limitations imposed on applications that require large storing capacities at high discharge rates, i.e. high power.

### SUMMARY

There is described a storage device configured to store energy at one or more given voltage levels. There is also described a storage circuit that may form part of a storage device and is responsible for storing electrical energy and discharging the electrical energy. And finally, there is described a modular circuit having a plurality of storage devices connected in series. The storage devices store electrical energy and provide a voltage level that may be switched in and out of the chain of storage devices in order to control an overall voltage level of the circuit. Each storage device may be individually protected from overvoltage while globally controlled for a given function.

In accordance with a first broad aspect, there is provided a storage device comprising an energy storage circuit comprising a storage element connected to at least one switching device, the at least one switching device configured for charging and discharging the storage element and for selectively bypassing the storage element; a power circuit operatively connected to the energy storage circuit and having circuit logic for generating an operating voltage using a voltage across the storage element; and a protection circuit operatively connected to the energy storage circuit and power circuit and having circuit logic for receiving command signals for opening and closing the switching devices while ensuring that at least one of the pair of switching devices is always open.

In accordance with another broad aspect, there is provided an energy storage circuit comprising a storage element having a positive terminal and a negative terminal; a first switching device having a first terminal and a second terminal, the second terminal operatively connected to the positive terminal of the storage element; a second switching device having a third terminal and a fourth terminal, the third terminal operatively connected to the first terminal of the first switching device, the fourth terminal operatively connected to the negative terminal of the storage element; a charging diode operatively connected across the first switching device at the first terminal and the second terminal; and a bypassing diode operatively connected across the second switching device at the third terminal and the fourth terminal.

In accordance with yet another broad aspect, there is provided a circuit comprising a plurality of storage devices according to any one of the embodiments described herein, connected in series and configured to store energy at one or more given voltage levels; and a controller operatively connected to the storage devices for selectively soliciting a voltage contribution from each one of the storage devices in order to generate a total voltage.

### BRIEF DESCRIPTION OF THE DRAWINGS

Further features and advantages of the present invention will become apparent from the following detailed description, taken in combination with the appended drawings, in which:

FIG. 1 is a block diagram of an exemplary circuit having multiple storage devices connected in series and controlled by a controller;

FIG. 2 is a block diagram of an exemplary embodiment for a storage device;

FIG. 3 is a schematic of an exemplary embodiment for two storage circuits connected in series;

FIG. 4 is a circuit diagram of an exemplary embodiment for a two-level storage circuit;

FIG. 5 is a circuit diagram of an exemplary embodiment for a power circuit;

FIGS. 6a and 6b are circuit diagrams of an exemplary embodiment for a protection circuit; and

FIG. 7 is a schematic of an exemplary embodiment for a power converter using series connected storage devices.

It will be noted that throughout the appended drawings, like features are identified by like reference numerals.

### DETAILED DESCRIPTION

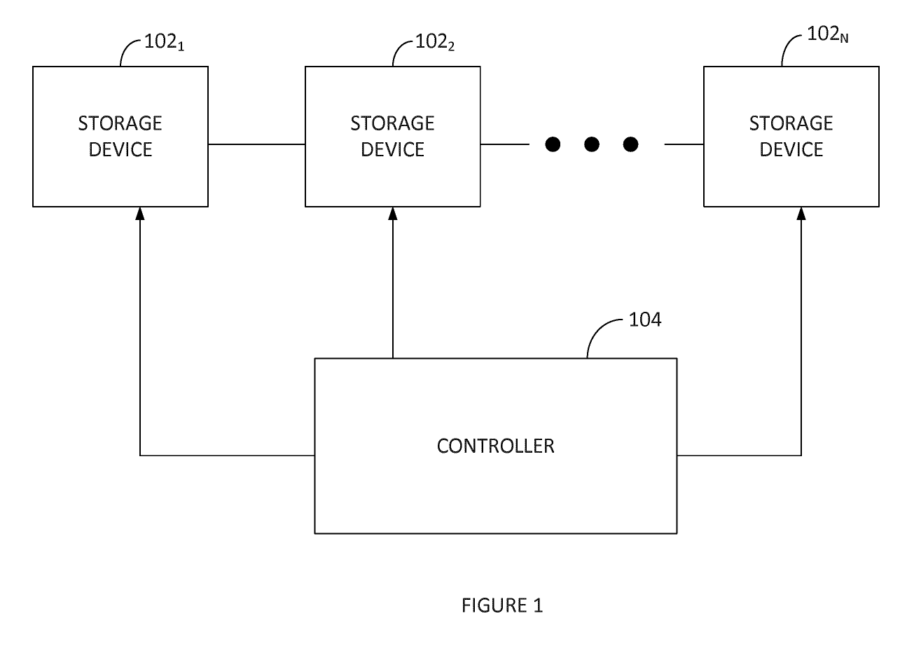

FIG. 1 is a block diagram of an exemplary circuit for various applications, such as power conversion. The circuit is modular and comprises a desired number of storage devices 102₁, 102₂, . . . , 102_{N}, connected in series. The storage devices 102₁, 102₂, . . . , 102_{N} are configured to store energy at one or more given voltage levels and may be connected together to provide a specific function. They may be controlled by an external controller 104 programmed with a logic for the specific function. For example, the circuit may be any one of a DC/DC, DC/AC, AC/DC, AC/AC power converter, as will be explained in more detail below. The external controller 104 manages the storage devices 102₁, 102₂, . . . , 102_{N} by soliciting the participation of any one of the storage devices 102₁, 102₂, . . . , 102_{N} in the function at any given time. The controller 104 may be a microcontroller, such as an EEPROM/EPROM/ROM-based CMOS microcontroller chip. It may have a small and simple 4 bit processor or a more complex 32 or 64 bit processor. Various microcontroller architectures may be used, such as Intel 8051, MIPS, Microchip Technology PIC, and ARM core processors. Alternatively, other types of control technology may be used, such as a programmable logic controller (PLC) or a digital signal processor (DSP).

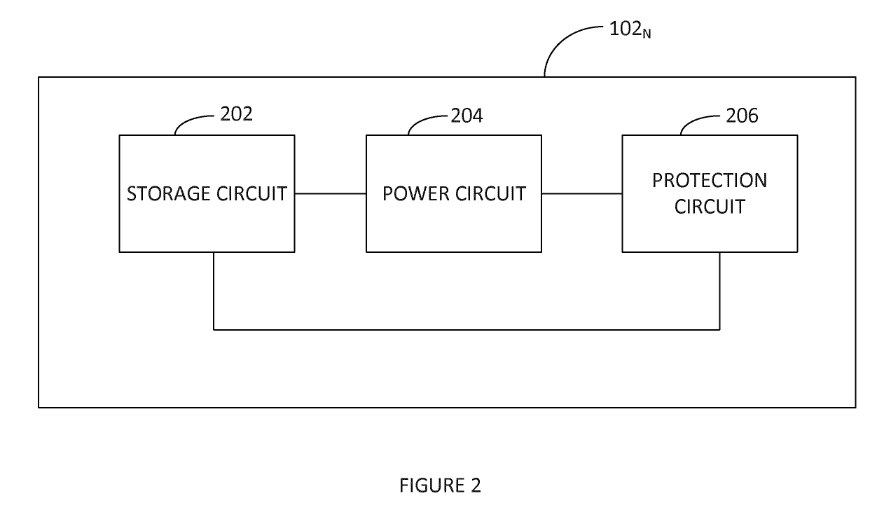

As per the embodiment illustrated in FIG. 2, each one of the storage devices 102_{N} may comprise a storage circuit 202, a power circuit 204, and a protection circuit 206. The storage circuit 202 is responsible for storing electrical energy and discharging the electrical energy. The energy may be stored at various voltage levels. When solicited by the controller 104, the storage device 102_{N} contributes a voltage to the chain of storage devices 102₁, 102₂, . . . , 102_{N}. When not solicited, the storage device 102_{N} is bypassed and does not contribute to the total voltage. The power circuit 204 is responsible for generating a sufficiently high voltage for powering the protection circuit 206 from the voltage stored in the storage circuit 202. The voltage generated by the storage circuit 202 is a low voltage and the power circuit 204 increases the low voltage to a higher level. The protection circuit 206 ensures that the voltage of the storage circuit 202 does not exceed the maximum allowed value for the capacitors. It also acts as an interface with the controller 104 in order to isolate electrically the storage circuit 202 from the controller 104. As the controller 104 may be used to manage a large number of storage devices 102₁, 102₂, . . . , 102_{N}, the protection circuit 206 prevents a potentially high voltage from being applied to the storage circuit 202 beyond its limit. While the storage circuit 202, power circuit 204, and protection circuit 206 are illustrated as distinct entities, they may share components in their respective circuits.

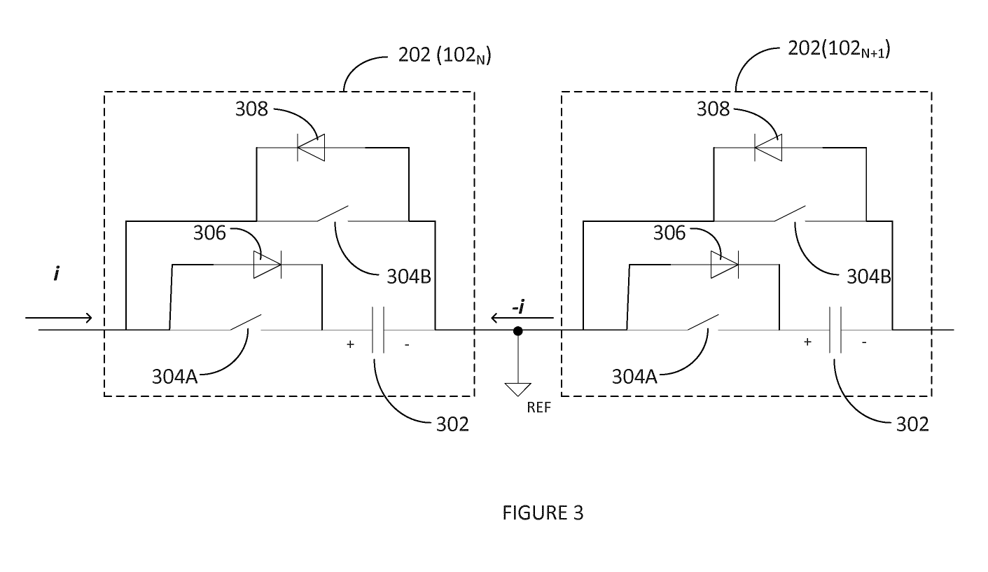

FIG. 3 is an exemplary embodiment of a storage circuit 202 from a first storage device 102_{N} connected in series with another storage circuit 202 from a second storage device 102_{N+1}. The power circuits 204 and protection circuits 206 of each storage device 102_{N}, 102_{N+1} are not illustrated in this figure for ease of teaching. In this example, each storage circuit 202 comprises a storage element 302, which may be a capacitor, a supercapacitor, an ultracapacitor, a battery, or any other passive element capable of storing and discharging energy. The supercapacitor may be a double-layer capacitor, a pseudocapacitor or a hybrid capacitor. The storage element 302 may also be a combination of capacitors, supercapacitors, ultracapacitors, and/or batteries, to obtain a desired voltage level. For example, a 5000 Farad supercapacitor may be used, or a pair of 10000 Farad capacitors connected in series may be used. The storage element 302 may have other values. Other configurations for the storage element 302 may also be used.

A pair of switching devices 304a, 304b, are connected to the storage element 302 for controlling a current path across the storage element 302. When switching device 304a is closed and switching device 304b is open, a current i travelling into the storage circuit 202 may flow through the storage element 302. When switching device 304b is closed and switching device 304a is open, the current i travelling into the storage circuit 202 may bypass the storage element 302. A charging diode 306 allows a positive current i to charge the storage element 302 even if switching device 304a is open, without allowing the storage element 302 to discharge from an inverse current −i. A bypass diode 308 allows an inverse current −i to bypass the storage element 302 even when switching device 304b is open. The protection circuit 206 may be configured to ensure that switching devices 304a and 304b are never closed at the same time. Note that the switching devices 304a, 304b are illustrated as single pole, single throw. Single pole double throw and/or single pole triple throw switching devices may also be used. In such a configuration, a single switching device may be used with a single storage element in each storage circuit 202.

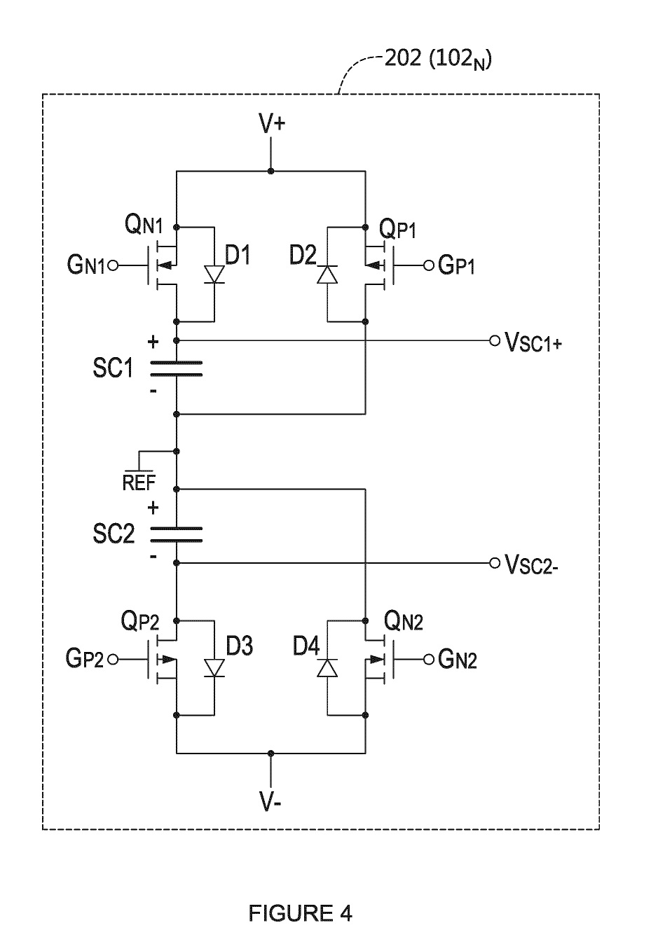

FIG. 4 is another embodiment for the storage circuit 202 of the storage device 102_{N}. In this example, two supercapacitors SC1, SC2 are used as storage element 302 in order to provide a two level storage device 102_{N}. Each supercapacitor SC1, SC2 is capable of supporting a voltage of, for example, 2.5 volts and thus, each storage device may be set to 0 volts, 2.5 volts, or 5 volts by managing the charging and discharging of the storage elements 302. Current may thus flow through both SC1 and SC2, only one of SC1 and SC2, or neither one of SC1 and SC2. This provides an overall voltage that may be controlled by increments of 2.5 volts or less, depending on the state of charge of the capacitor. Note that only the upper or lower portion of the circuit may be used with a single supercapacitor capable of supporting a voltage of 5 volts, thus providing an overall voltage that may be controlled by increments of 5.0 volts or less, depending on the state of charge of the capacitor.

Each supercapacitor is provided with a pair of switching devices 304a, 304b, namely two n-channel transistors Q_{N1}, Q_{N2} and two p-channel transistors Q_{P1}, Q_{P2}. In this example, the transistors are Metal-Oxide-Semiconductor Field-Effect Transistors (MOSFETs), but they may also be other types of semiconductor switching devices, such as diodes, thyristors and bipolar junction transistors (BJTs). Other types of solid state switching technology, such as a solid state relay or a solid state contactor, may also be used. In some embodiments, mechanical or electro-mechanical switches may also be used. When transistors Q_{N1} and Q_{P2} are closed, they allow current to flow in SC1 and SC2, respectively. When transistors Q_{P1} and Q_{N2} are closed, current may bypass SC1 and SC2, respectively. Diodes D1 and D3 allow a positive current to recharge SC1 and SC2, respectively, even when Q_{N1} and Q_{P2} are open. Diodes D2 and D4 allow an inverse current to bypass SC1 and SC2, respectively, even when Q_{N2} and Q_{P1} are open. Transistors Q_{N1}, Q_{N2}, Q_{P1}, Q_{P2} are operated by gate signals G_{N1}, G_{N2}, G_{P1}, G_{P2}, respectively, generated by the protection circuit 206, itself triggered by the controller 104. In the embodiment illustrated in FIG. 4, all of the components of the storage circuit 202 are low voltage components (less than 10 Volts) and are thus very inexpensive. Alternatively, other components may be used to implement the storage circuit 202, and more particularly to provide the storage element 302 and the switching devices 304a, 304b.

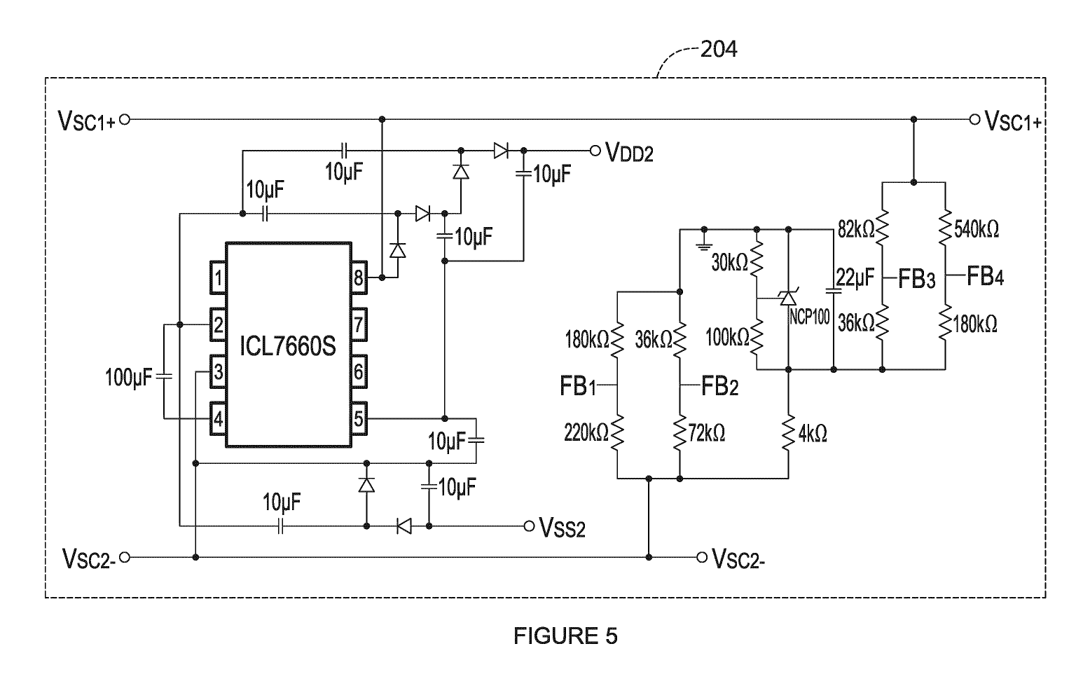

FIG. 5 is an exemplary embodiment for the power circuit 204 of FIG. 2. In this example, the power circuit 204 mainly comprises a voltage converter integrated circuit (ICL7660S) and a shunt voltage regulator (NCP100). The voltage converter integrated circuit is used to produce a voltage level sufficiently high to generate the command signals on the transistor gates G_{N1}, G_{N2}, G_{P1}, G_{P2}, so that the transistors exhibit a very low resistance when in an “on” state, instead of acting in linear mode like in class A amplifiers. Four voltage dividers (FB1, FB2, FB3, FB4) are also formed of a plurality of resistors. In the example illustrated, the voltage V_{DD2} is about 11 volts and V_{SS2} is about −6.5 volts, when voltages V_{SC1+} and V_{SD2-} are +2.5 volts and −2.5 volts, respectively. The shunt voltage regulator is connected so as to provide a voltage of −0.9 volts at its anode. This voltage serves as a reference voltage for a comparator (provided in the protection circuit 206) to determine if the voltages at FB1-FB4 of the voltage dividers reach a critical value. This critical value is reached when the voltage across each one of SC1 and SC2 is below 2.0 volts or above 2.7 volts, i.e. the voltage limits of the storage elements 302 used. An estimated value of 2.0 volts is hereby used as a minimum value to ensure that all of the components of the power circuit 204 in this example function properly. Other values may also be used, depending on various factors such as the storage elements, the switching devices, and the components of the power circuit 204. The example of FIG. 5 is for illustration purposes only. The power circuit 204 may be provided using an alternative configuration comprising circuit logic for generating an operating voltage using the voltage across the storage element 302.

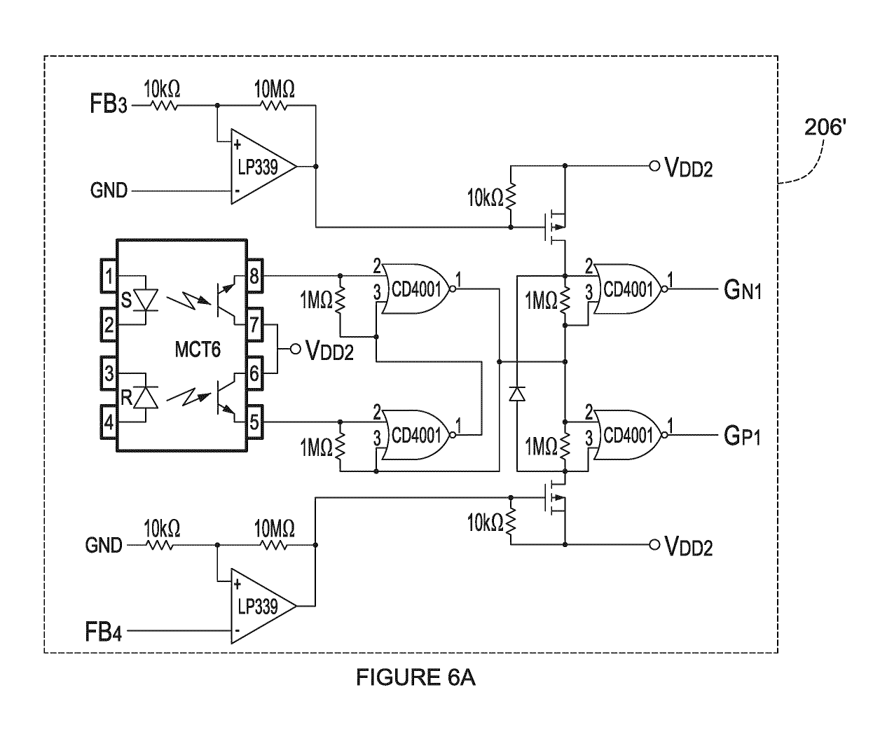

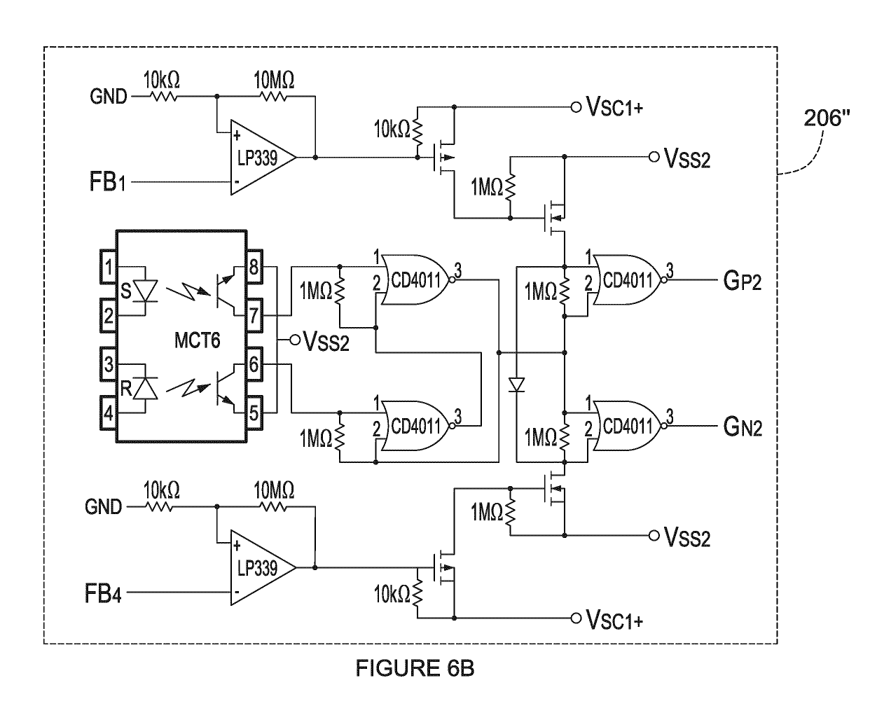

FIGS. 6a and 6b are exemplary embodiments of the protection circuit 206 for the storage circuit 202 of FIG. 4 and the power circuit 204 of FIG. 5. Circuit 206′ protects and controls the top portion of the storage circuit 202 (i.e. with Q_{N1} and Qₚ₁), while circuit 206″ protects and controls the lower portion of the storage circuit 202 (i.e. with Q_{N2} and Q_{P2}). A low power quad comparator (LP339) is used as described above to monitor the voltage levels of the voltage dividers FB1-FB4. The comparator may alternatively be provided in the power circuit 204 instead of the protection circuit 206. NOR and NAND gates are used to form RS latches for activating the transistors while ensuring that any storage device 102_{N} is not required to be both active and passive at the same time. Such a scenario would cause a short-circuit across the storage element 302. An opto-coupler (MCT6) isolates the storage circuit 202 from the controller 104. This is useful as having a large number of storage devices 102₁, 102₂, . . . , 102_{N}, connected in series may bring the local reference voltage of a storage device 102_{N} to several hundreds of volts, despite the storage device 102_{N} having its own voltage levels bounded below a low value, such as 20 volts. The examples of FIGS. 6a and 6b are for illustration purposes only. The protection circuit 206 may be provided using an alternative configuration comprising circuit logic for receiving control signals for opening and closing the switching devices 304a, 304b while ensuring that at least one of the switching devices 304a, 304b is always open.

A single storage device 102_{N} controlled by a controller 104 is sufficient for the circuit to be functional. Using multiple storage devices 102₁, 102₂, . . . , 102_{N} connected in series provides a circuit whereby each storage device 102_{N} may be controlled individually by being either activated or bypassed. The voltage across such a circuit is the sum of the voltages across the storage elements in the chain that are active, i.e. not bypassed. Individual protection and control is provided for each storage circuit while a single external control is needed for all of the storage devices 102₁, 102₂, . . . , 102_{N}.

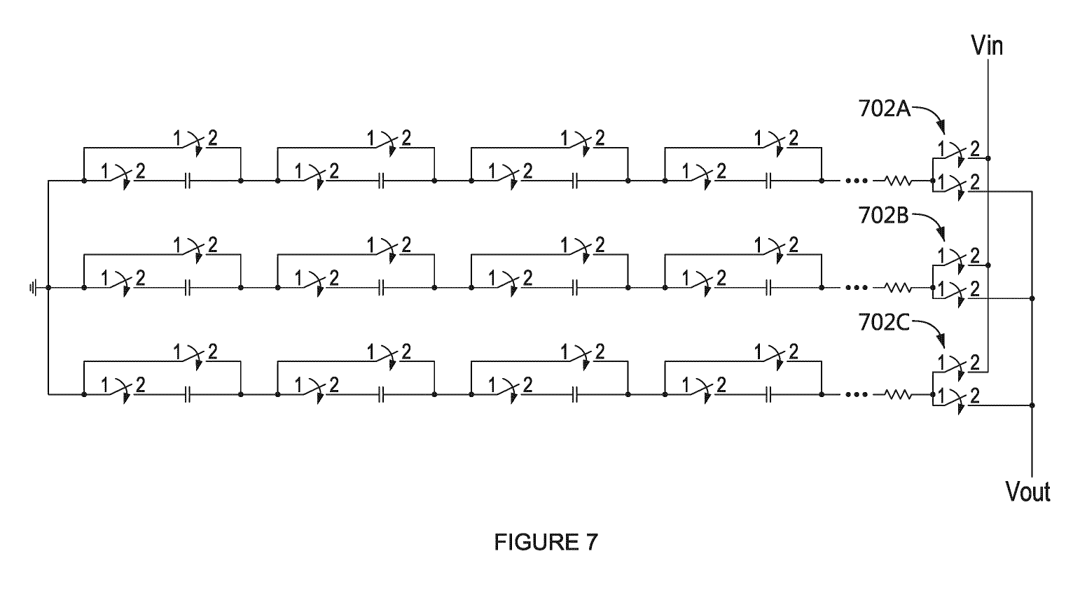

Such a circuit may be used for various applications, such as power conversion, by connecting multiple groups of storage devices in separate branches. An example is illustrated in FIG. 7 (only the storage circuits 202 are illustrated for ease of teaching), whereby many storage devices 102₁, 102₂, . . . , 102_{N} are connected together to form a DC/DC converter. Note that the same configuration may be used to generate AC if combined with a polarity inverter at its output to reverse the polarity of the output voltage. In this example, one branch is connected to a source Vᵢₙ via a power switch 702a, such as an insulated gate bipolar transistor (IGBT). The IGBT may be sized as a function of the overall voltage of the system. The power switch 702a may be any switching device designed to switch significant power. The controller 104 ensures that the voltage across this branch corresponds to the input voltage, so as to keep the input voltage within a reasonable range. The storage elements 302 of this branch are recharged by the current coming from the source. A second branch is connected via another power switch 702b, to the output Vₒᵤₜ. The storage elements 302 of this branch supply a load (and thus discharge) and the controller 104 ensures that the output voltage is set to a desired value. This voltage may be constant or variable, as needed. By alternating the input and output connections between the two branches, successive charging and discharging of the storage elements 302 occurs. Any output voltage level may be generated from any input voltage level by providing the appropriate input commands to the series connected storage devices 102₁, 102₂, . . . , 102_{N}. The third branch, connected to Vᵢₙ, and Vₒᵤₜ by power switch 702c, is used to provide a smooth transition when switching between the first and the second branch and is optional.

By changing the number of branches, the configuration of the power switches between the branches, and/or the logic providing the control signals from the controller 104 to the storage devices 102₁, 102₂, . . . , 102_{N}, other power converting circuits may also be obtained, namely DC/AC, AC/DC, and AC/AC. Contrary to conventional power converting circuits, high frequency switching is not required, even for the power switches 702a, 702b, 702c connecting the various branches together. In addition, such a power converter can store a considerable amount of energy, which provides a certain autonomy in the case of a momentary interruption from the power source. Depending on the overall storage capacity of the system, autonomy may be provided for anywhere from several seconds to several minutes. This is particularly useful for applications where power demands are very irregular, or where a smoothing of energy consumption is desirable, such as for wind power applications or electric vehicles.

Note that in a worst case scenario, the resolution of the output voltage is equal to the voltage of the storage element. In the example above, this value is about 2.7 volts. If this resolution is insufficient on a scale of many hundreds of volts, a pulse width modulator (PWM) may be placed at the output of a storage device in order to tweak the voltage. Since a single storage device may operate at a maximum voltage of 5.4 volts, switching losses and electromagnetic emissions typically associated with power converters are minimal. Other configurations of the storage device 102_{N} may be used with a polarity inverter at its output to reverse the polarity of the output voltage.

Other exemplary applications for the embodiments as described herein using the storage devices 102₁, 102₂, . . . , 102_{N} involve recovering braking energy in trains, subways, cars, bicycles, and other vehicles. Recovered energy may be stored and used in various ways. For example, the system can be used onboard for mobile storage. To that end, the system can, for example, be installed on the vehicle's roof. The recovered energy is thus stored locally and used as a source of energy for accelerating the vehicle. In another example, the system may be used for stationary storage. In this case, the storage devices may be positioned along rails. The recovered braking energy can be stored and used by any vehicle circulating on the tracks, the storage devices feeding the energy back to the power supply system when an accelerating train needs it. In yet another example, instead of powering the trains, the recovered energy can simply be sent back to the electrical grid and thus be used for everything from lighting to heating or powering any other electrical device. Any other application requiring fast storage of electrical energy that may be re-injected into a system may benefit from such a circuit composed of the storage devices 102₁, 102₂, . . . , 102_{N}.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The embodiments of the invention described above are intended to be exemplary only. The scope of the invention is therefore intended to be limited solely by the scope of the appended claims.

1. A storage device comprising:
an energy storage circuit comprising a storage element connected to at least one switching device, the at least one switching device configured for charging and discharging the storage element and for selectively bypassing the storage element;
a power circuit operatively connected to the energy storage circuit and having circuit logic for generating an operating voltage using a voltage across the storage element; and
a protection circuit operatively connected to the energy storage circuit and power circuit and having circuit logic for receiving command signals for opening and closing the switching devices while ensuring that at least one of the pair of switching devices is always open.

2. The storage device of claim 1, wherein the storage element has a positive terminal and a negative terminal, and wherein the at least one switching device comprises a first switching device connected to the positive terminal and a second switching device connected to the negative terminal.

3. The storage device of claim 2, wherein:
the first switching device has a first terminal and a second terminal, the second terminal operatively connected to the positive terminal of the storage element;
the second switching device has a third terminal and a fourth terminal, the third terminal operatively connected to the first terminal of the first switching device, the fourth terminal operatively connected to the negative terminal of the storage element;
and further comprising:
a charging diode operatively connected across the first switching device at the first terminal and the second terminal; and
a bypassing diode operatively connected across the second switching device at the third terminal and the fourth terminal.

4. The storage device of any one of claims 1 to 3, wherein the storage element comprises at least one of a capacitor, a supercapacitor, and an ultracapacitor.

5. The storage device of claim 1, wherein the storage element comprises a pair of supercapacitors connected with the at least one switching device to allow current to flow through any one of both supercapacitors, one of the supercapacitors, and none of the supercapacitors, to provide the storage device with three voltage levels.

6. The storage device of claim 5, wherein the at least one switching device comprises two pairs of semiconductor switching devices.

7. The storage device of claim 6, wherein the pairs of semiconductor switching devices each comprise an n-channel transistor and a p-channel transistor.

8. The storage device of any one of claims 1 to 7, wherein the power circuit comprises a voltage converter integrated circuit to generate the command signals, and a shunt voltage regulator to generate a reference voltage.

9. The storage device of any one of claims 1 to 8, wherein the protection circuit comprises at least one comparator to monitor voltage levels in the power circuit, logic gates to form latches, and at least one opto-coupler to isolate the energy storage circuit from a controller.

10. An energy storage circuit comprising:
a storage element having a positive terminal and a negative terminal;
a first switching device having a first terminal and a second terminal, the second terminal operatively connected to the positive terminal of the storage element;
a second switching device having a third terminal and a fourth terminal, the third terminal operatively connected to the first terminal of the first switching device, the fourth terminal operatively connected to the negative terminal of the storage element;
a charging diode operatively connected across the first switching device at the first terminal and the second terminal; and
a bypassing diode operatively connected across the second switching device at the third terminal and the fourth terminal.

11. The energy storage circuit of claim 10, wherein the storage element comprises at least one of a capacitor, a supercapacitor, and an ultracapacitor.

12. The energy storage circuit of claim 10, wherein the storage element, the first switching device, the second switching device, the charging diode, and the bypassing diode form a first level of the energy storage circuit, and a second level comprises a second storage element, a second pair of switching devices, a second charging diode, and a second bypassing diode.

13. The energy storage circuit of claim 12, wherein each of the first level and the second level comprise an n-channel transistor and a p-channel transistor as switching devices.

14. A circuit comprising:
a plurality of storage devices according to any one of claims 1 to 9, connected in series and configured to store energy at one or more given voltage levels; and
a controller operatively connected to the storage devices for selectively soliciting a voltage contribution from each one of the storage devices in order to generate a total voltage.

15. The circuit of claim 14, wherein the plurality of storage devices are also connected together to provide a specific function, and the controller comprises logic for the specific function.

16. The circuit of claim 15, wherein the specific function is power conversion, and the circuit is any one of a DC/DC, DC/AC, AC/DC, AC/AC power converter.

17. The circuit of claim 15 or 16, wherein the plurality of storage devices are connected as multiple branches between a power source and a ground.

18. The circuit of claim 17, further comprising a polarity inverter at an output of the circuit to reverse a polarity of an output voltage and generate an alternating current.

19. The circuit of any one of claims 14 to 18, wherein the controller is a microcontroller chip.

20. The circuit of any one of claims 14 to 19, further comprising a pulse width modulator at an output of at least one of the storage devices
